(19) United States
(12) Patent Application Publication
(10) Pub. No.: US 2008/0012882 A1
(43) Pub. Date: Jan. 17, 2008

(54) Digital Filter and Image Processing Apparatus Using the Same

(75) Inventor: Yukio Koyanagi, Saitama-shi (JP)

Correspondence Address: CONNOLLY BOVE LODGE & HUTZ LLP, 1875 EYE STREET, N.W., SUITE 1100, WASHINGTON, DC, 20036, US

(73) Assignee: NEURO SOLUTION CORP., Tokyo (JP)

(21) Appl. No.: 11/775,969

(22) Filed: Jul. 11, 2007

(30) Foreign Application Priority Data
Jul. 13, 2006 (JP) 2006-192275

(51) Int. Cl. G09G 5/00; G06F 17/17

(52) U.S. Cl. 345/660; 708/313

(57) ABSTRACT

An over-sampling unit 2 that over-samples inputted sequential respective sample values to be N sample values and an FIR filter unit 3 that applies filter processing to the over-sampled respective sample values using coefficients formed by a sequence of numerical values (1/2N², 3/2N², 5/2N², . . . , (N−3)/2N², (N−1)/2N², (N−1)/2N², (N−3)/2N², . . . , 5/2N², 3/2N², 1/2N²} (when N is an even number) are provided. Consequently, original discrete sample points are smoothly interpolated along a spline curve according to over-sampling and FIR filter processing and, in a frequency characteristic of an output, a pass band is limited to 2/N of a sampling frequency.

### BACKGROUND OF THE INVENTION

1. Field of the Invention

The present invention relates to a digital filter and an image processing apparatus using the same. More particularly, the present invention is suitably used for a digital filter of an FIR (Finite Impulse Response) type and an image processing apparatus that performs enlargement and reduction of an image using the digital filter.

2. Description of the Related Art

Conventionally, as a data interpolation method for calculating a value between given discrete data, various methods have been proposed. A data interpolation technique using the data interpolation method is applied in various fields. For example, it is possible to enlarge an image by applying data interpolation to a pixel value of the image. It is also possible to give various acoustic effects by applying the data interpolation to sound data.

A most simple method of the data interpolation is linear interpolation. However, in the case of the linear interpolation, it is impossible to smoothly interpolate original data. As a method of smoothly interpolating data, there is also known a method of performing the data interpolation using a predetermined interpolation function. A function well known as the interpolation function is a sinc function. However, this is a function that converges to 0 at ±∞. Therefore, a truncation error is inevitably included in an interpolation value obtained by an interpolation operation that uses this sinc function.

As an example of the data interpolation, there is proposed a method of applying over-sampling to a sample value sequence of a digital signal and applying interpolation processing to respective sample values obtained by the over-sampling (see, for example, Japanese Patent Laid-Open No. 5-315891). There is also proposed a method of over-sampling an inputted variable number of data in a band-limiting over-sampling unit and, then, linearly interpolating the data in a liner interpolation unit and curtailing the data in a curtailment processing unit to convert the data into a fixed number of sample data (see, for example, Japanese Patent Laid-Open No. 5-297898).

However, when the interpolation processing is performed using the conventional interpolation function such as the sinc function, information originally present cannot be sufficiently covered in the process of signal processing and aliasing noise occurs from the information not covered. Therefore, as described in Japanese Patent Laid-Open No. 5-315891, a low-pass filter (anti-alias filter) has to be provided at a post stage of the interpolation processing unit in order to remove the aliasing noise caused by the interpolation processing.

On the other hand, in the technique described in Japanese Patent Laid-Open No. 5-297898, when the over-sampling is performed, a plural number of 0 values are inserted between number sequences and low-pass filter processing is substantially performed according to the insertion of the 0 values. This makes it unnecessary to provide the anti-alias filter at the post stage of the interpolation processing unit. However, whereas the anti-alias filter is unnecessary at the post stage of the interpolation processing unit, a structure for the 0 value insertion is necessary in the over-sampling unit.

### SUMMARY OF THE INVENTION

The present invention has been devised to solve the problems and it is an object of the present invention to make it possible to smoothly interpolate discrete data and remove aliasing noise with an extremely simple structure without providing the anti-alias filter and the structure for the 0 value insertion.

In order to solve the problems, a digital filter according to the present invention over-samples inputted sequential respective sample values to be N sample values and, then, applies filter processing to the over-sampled respective sample values using coefficients formed by a sequence of numerical values {1/2N², 3/2N², 5/2N², . . . , (N−3)/2N², (N−1)/2N², (N−1)/2N², (N−3)/2N², . . . , 5/2N², 3/2N², 1/2N²} (when N is an even number) or {1/2N(N+1), 3/2N(N+1), 5/2N(N+1), . . . , (N−2)/2N(N+1), (N−1)/2N(N+1), (N−2)/2N(N+1), . . . , 5/2N(N+1), 3/2N(N+1), 1/2N(N+1)} (when N is an odd number).

An image processing apparatus according to the present invention interpolates an original image to be an image N1 times (N=N1) as large as the original image in the vertical direction and, then, interpolates the image enlarged to be N1 times as large as the original image in the vertical direction to be an image N2 times (N=N2) as large as the image in the horizontal direction using the digital filter constituted as described above. Moreover, the image processing apparatus may enlarge the image enlarged to be N1 times as large as the original image in the vertical direction to be an image 1/M1 times as large as the image in the vertical direction according to curtailment processing and enlarge the image enlarged to be N2 times as large as the image to be an image 1/M2 times as large as the image in the horizontal direction according to the curtailment processing. Here, N1 may be equal to N2 and M1 may be equal to M2.

According to the present invention constituted as described above, original discrete sample points are smoothly interpolated along a spline curve according to the over-sampling and the FIR filter processing having the predetermined filter coefficients. Besides, in a frequency characteristic of an output, a pass band is limited to 2/N of a sampling frequency.

The spline curve realized by sample values outputted from the FIR filter unit having the predetermined filter coefficients indicates a function having finite values other than “0” only in a fixed section and having all values of “0” in other areas, i.e., an interpolation function of a finite base, a value of which converges to “0” in a predetermined sample position. In such an interpolation function of the finite base, only data in local areas having finite values other than “0” have a meaning. Data in areas other than the areas are not neglected despite the fact that the data should originally be considered. Rather, the data do not have to be logically taken into account. Thus, a truncation error does not occur.

Therefore, according to the present invention, it is possible to smoothly interpolate discrete data and at the same time suppress occurrence of aliasing noise without providing the low-pass filter at the post stage of the interpolation processing unit and providing the structure for the 0 value insertion in the over-sampling unit.

### BRIEF DESCRIPTION OF THE DRAWINGS

FIG. 1 is a diagram showing an example of a structure of a digital filter according to an embodiment of the present invention;

FIG. 2 is a diagram showing an example of a structure of an FIR filter unit according to the embodiment;

FIG. 3 is a diagram showing an example of an arithmetic operation of the FIR filter unit according to the embodiment;

FIG. 4 is a graph showing an output waveform of the FIR filter unit according to the embodiment;

FIGS. 5A and 5B are diagrams showing an example of another arithmetic operation for obtaining outputs same as those in the FIR filter unit according to the embodiment;

FIGS. 6A and 6B are diagrams showing an example of a structure of the FIR filter unit according to the embodiment;

FIG. 7 is a graph showing a frequency characteristic of a first FIR filter according to the embodiment;

FIG. 8 is a graph showing a frequency characteristic of the FIR filter unit according to the embodiment;

FIG. 9 is a diagram showing an example of an arithmetic operation of the FIR filter unit according to the embodiment;

FIG. 10 is a graph showing an output waveform of the FIR filter unit according to the embodiment;

FIGS. 11A and 11B are diagrams showing an example of a structure of the FIR filter unit according to the embodiment;

FIG. 12 is a diagram showing an example of a structure of an image processing apparatus according to the embodiment; and

FIG. 13 is a diagram showing an example of another structure of the image processing apparatus according to the embodiment.

### DETAILED DESCRIPTION OF THE PREFERRED EMBODIMENTS

An embodiment of the present invention will be hereinafter explained with reference to the accompanying drawings. FIG. 1 is a diagram showing an example of a structure of a digital filter according to this embodiment. In FIG. 1, reference numeral 1 denotes a D type flip-flop. The D type flip-flop 1 functions as a buffer that sequentially holds sequentially inputted sample values in accordance with a clock ck0 of a reference frequency.

Reference numeral 2 denotes a D type flip-flop for over-sampling (corresponding to the over-sampling unit of the invention). The D type flip-flop 2 repeatedly obtains inputted sequential respective sample values at every N (N is an integer equal to or larger than 2) over-sampling periods to over-sample the respective sample values to be N times as many as the sample values. In other words, the over-sampling unit 2 sequentially holds and outputs sample values inputted from the D type flip-flop 1 at the pre-stage in accordance with a clock N*ck0 of an N-time frequency. For example, when a sample value “1” is inputted to the D type flip-flop 1 for buffer, if N is 8, a sequence of eight numbers “1, 1, 1, 1, 1, 1, 1, 1” is outputted from the over-sampling unit 2 according to the over-sampling.

Reference numeral 3 denotes an FIR filter unit. The FIR filter unit 3 applies filter processing to the respective sample values over-sampled by the over-sampling unit 2 using coefficients formed by a predetermined sequence of numerical values. The predetermined sequence of numerical values is {1/2N², 3/2N², 5/2N², . . . , (N−3)/2N², (N−1)/2N², (N−1)/2N², (N−3)/2N², . . . , 5/2N², 3/2N², 1/2N²} . . . (1) when N is an even number. The predetermined sequence of numerical values is {1/2N(N+1), 3/2N(N+1), 5/2N(N+1), . . . , (N−2)/2N(N+1), (N−1)/2N(N+1), (N−2)/2N(N+1), . . . , 5/2N(N+1), 3/2N(N+1), 1/2N(N+1)} . . . (2) when N is an odd number.

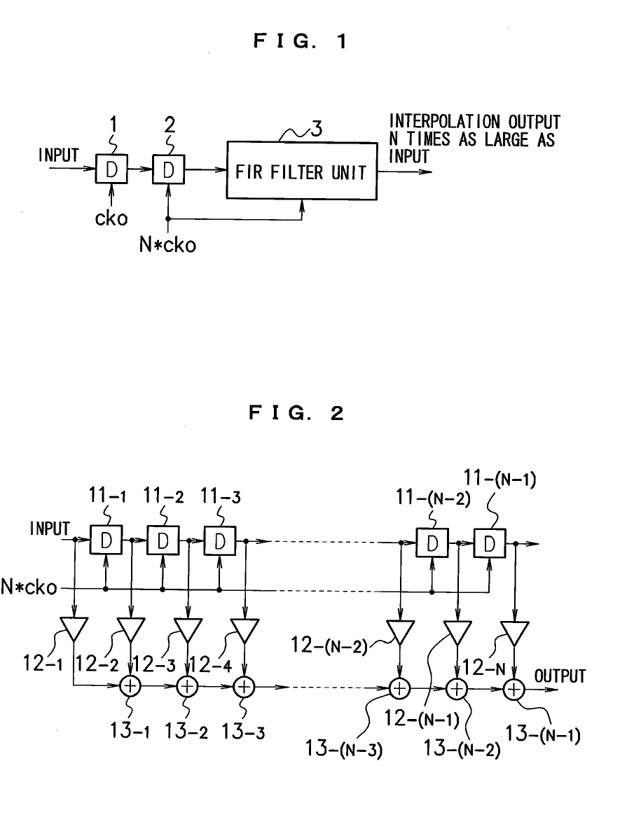

The FIR filter unit 3 sequentially delays input data with a tapped delay line formed by plural D type flip-flops. The FIR filter unit 3 multiplies N data outputted from input/output taps of the respective D type flip-flops by filter coefficients formed by the sequence of numerical values indicated by (1) or (2) above, adds up results of the multiplication, and outputs the results. In other words, the FIR filter unit 3 includes, as shown in FIG. 2, cascaded (N−1) D type flip-flops 11₋₁ to 11_{-(N-1)}, N coefficient units 12₋₁ to 12_{-N}, and (N−1) adders 12₋₁ to 12_{-(N-1)}.

The (N−1) D type flip-flops 11₋₁ to 11_{-(N-1)} sequentially delay the input data one clock at a time in accordance with the clock N*ck0 of the N-time frequency. The N coefficient units 12₋₁ to 12_{-N} multiply signals extracted from input/output taps of the D type flip-flops 11₋₁ to 11_{-(N-1)} by the filter coefficients formed by the sequence of numerical values indicated by (1) or (2) above, respectively. The (N−1) adders 13₋₁ to 13_{-(N-1)} add up all results of the multiplication of the coefficient units 12₋₁ to 12_{-N} and output the results.

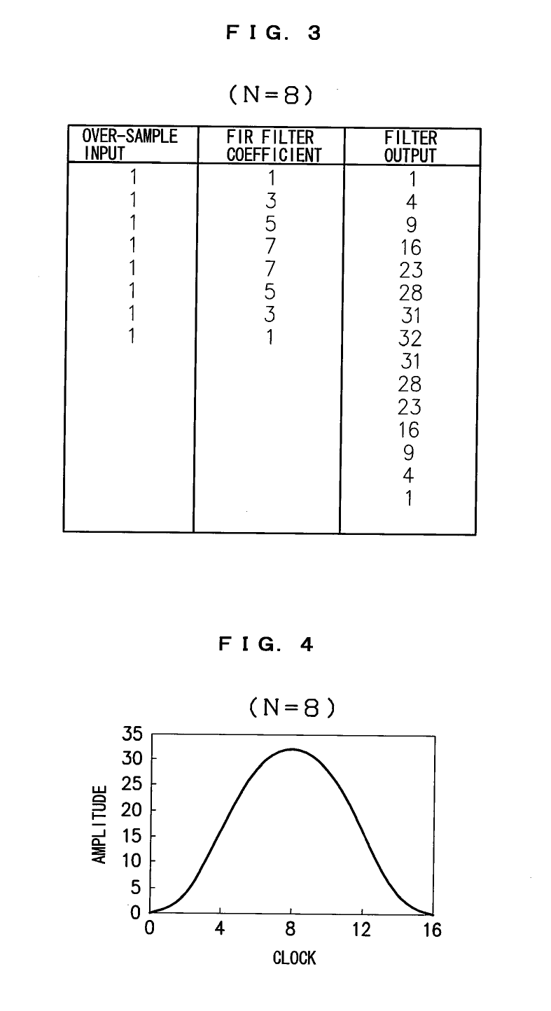

A meaning of the sequence of numerical values indicated by (1) or (2) above will be explained. As a characteristic of this sequence of numerical values, when the sequence of numerical values is set as filter coefficients of the FIR filter, a curve represented by a sequence of numerical values of a filter output obtained when a unit pulse with amplitude “1” is inputted to the over-sampling unit 2 becomes a spline curve of a finite base. This will be explained in detail with reference to FIGS. 3 to 8.

FIG. 3 is a diagram showing an example of an arithmetic operation of the FIR filter unit 3. FIG. 4 is a graph showing a curve represented by a sequence of numerical values calculated by the arithmetic operation in FIG. 3. Here, a multiple N of over-sampling is 8. Since N is an even number, the sequence of numerical values of (1) is used as filter coefficients. The sequence of numerical values in this case is specifically {1, 3, 5, 7, 7, 5, 3, 1} (for simplification of explanation, denominators are omitted).

As described above, when the unit pulse with amplitude “1” is inputted to the D type flip-flop 1 for buffer, the sequence of eight numerical values “1, 1, 1, 1, 1, 1, 1, 1” is outputted from the over-sampling unit 2 according to the implementation of the over-sampling. The FIR filter unit 3 inputs the sequence of numerical values “1, 1, 1, 1, 1, 1, 1, 1” generated by the over-sampling and applies the filtering processing to the sequence of numerical values using the filter coefficients formed by the sequence of numerical values {1, 3, 5, 7, 7, 5, 3, 1} to obtain a sequence of fifteen numerical values {1, 4, 9, 16, 23, 28, 31, 32, 31, 28, 23, 16, 9, 4, 1}.

When amplitude values of the sequence of fifteen numerical values are plotted on the ordinate and clock positions are plotted on the abscissa to form a graph, a graph shown in FIG. 4 is formed. A curve shown in FIG. 4 is a spline curve and indicates a function that has finite amplitude values other than “0” only in clock positions between 0 to 16 and has all amplitude values of “0” in other areas, i.e., an interpolation function of a finite base, an amplitude value of which converges to “0” in a predetermined sample position.

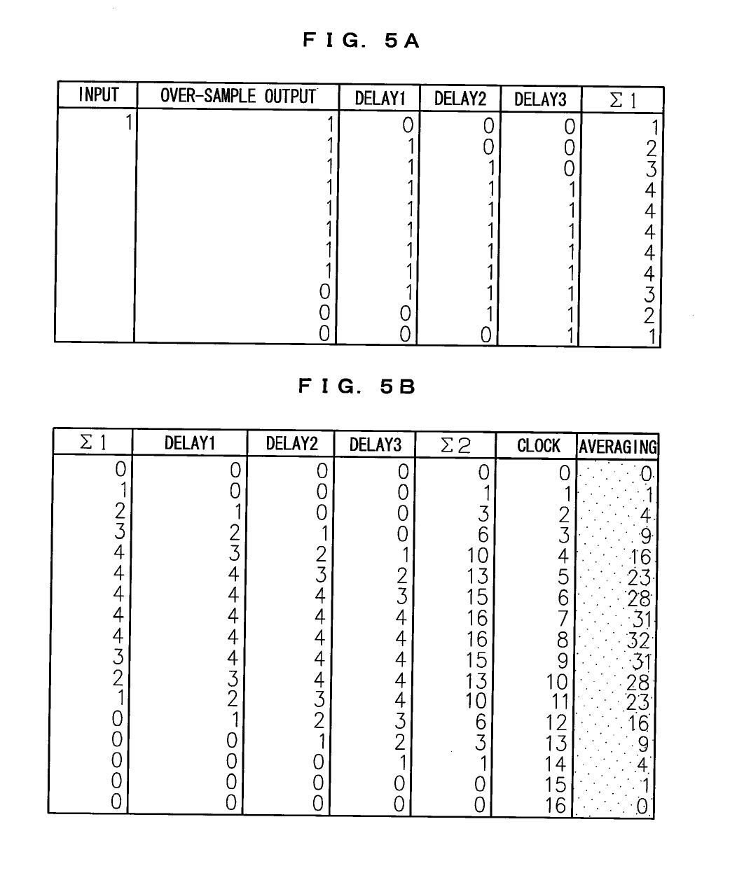

The sequence of numerical values {1, 4, 9, 16, 23, 28, 31, 32, 31, 28, 23, 16, 9, 4, 1} coincides with the sequence of numerical values generated by the interpolation processing method described in the publication of WO 00/68826 filed by the inventor in the past. FIGS. 5A and 5B are diagrams for explaining an example of an arithmetic operation by the interpolation processing method described in the publication. As shown in FIG. 5A, first, a sequence of eight numerical values “1, 1, 1, 1, 1, 1, 1, 1” is obtained by over-sampling an inputted unit pulse with amplitude “1” to be a unit pulse eight times as large as the unit pulse.

The sequence of eight numerical values is delayed at three stages by one clock at a time. The sequence of numerical values before the delay and sequences of numerical values obtained by the three stages of delay, respectively, are averaged (sequences of numerical values of an over-sample output, a delay 1, a delay 2, and a delay 3 in a row corresponding thereto shown in FIG. 5A are added up). Consequently, a convolution operation of three phases is executed and a sequence of eleven numerical values “1, 2, 3, 4, 4, 4, 4, 4, 3, 2, 1” is obtained.

Then, the sequence of eleven numerical values is delayed at three stages by one clock at a time. The sequence of numerical values before the delay and sequences of numerical values obtained by the three stages of delay, respectively, are averaged (sequences of numerical values of a Σ1, a delay 1, a delay 2, and a delay 3 in a row corresponding thereto shown in FIG. 5B are added up). Consequently, the convolution operation of three phases is executed and a sequence of fourteen numerical values “1, 3, 6, 10, 13, 15, 16, 16, 15, 13, 10, 6, 3, 1” is obtained. Moreover, by averaging the sequence of numerical values, the sequence of numerical values {1, 4, 9, 16, 23, 28, 31, 32, 31, 28, 23, 16, 9, 4, 1} shown in FIG. 3 is obtained.

In this embodiment, it is possible to acquire such a sequence of numerical values according to only a filter operation by the FIR filter unit 3 having the sequence of numerical values {1, 3, 5, 7, 7, 5, 3, 1} as filter coefficients without performing the complicated arithmetic operation described in the publication of WO 00/68826. Here, the sequence of numerical values {1, 3, 5, 7, 7, 5, 3, 1} will be explained more in detail.

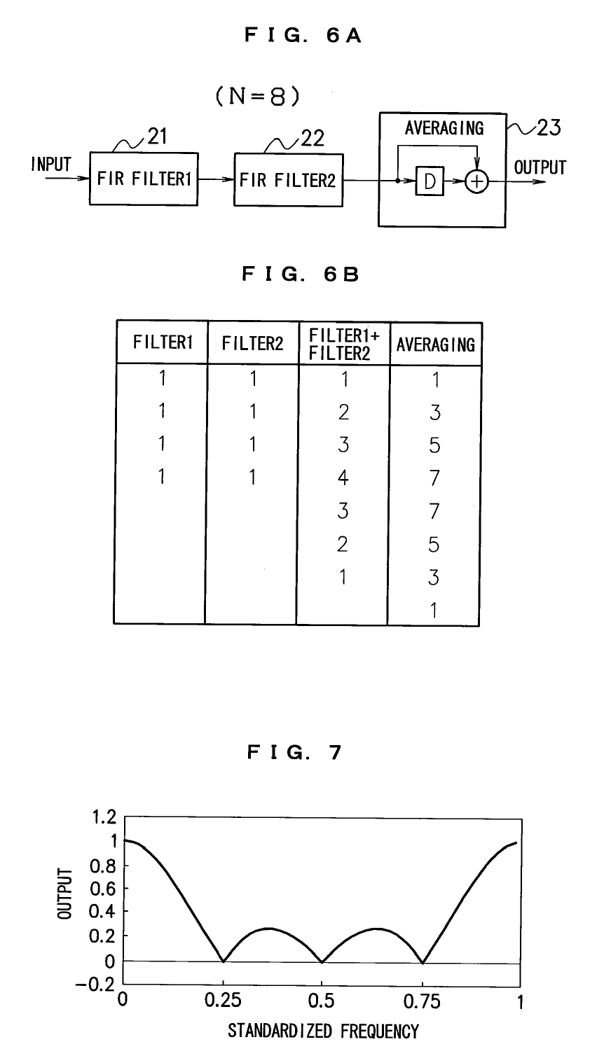

As shown in FIG. 6A, the sequence of numerical values {1, 3, 5, 7, 7, 5, 3, 1} is generated by a first FIR filter 21 having a sequence of numerical values {1, 1, 1, 1} as filter coefficients, a second FIR filter 22 having the sequence of numerical values {1, 1, 1, 1} as filter coefficients, and an averaging processing unit 23 that averages a sequence of numerical values outputted from the second FIR filter 22. The averaging in this context means processing for delaying a sequence of numerical values by one clock at a time and adding up original numerical values before the delay and numerical values delayed by one clock.

As shown in FIG. 6B, when the unit pulse with amplitude “1” is inputted to the first FIR filter 21, the unit pulse passes through the cascaded two FIR filters 21 and 22, whereby a sequence of numerical values {1, 2, 3, 4, 3, 2, 1} is generated. The sequence of numerical values is averaged by the averaging processing unit 23, whereby a sequence of numerical values {1, 3, 5, 7, 7, 5, 3, 1} is generated. The FIR filter unit 3 may be constituted as shown in FIG. 2 or may be constituted as shown in FIG. 6A.

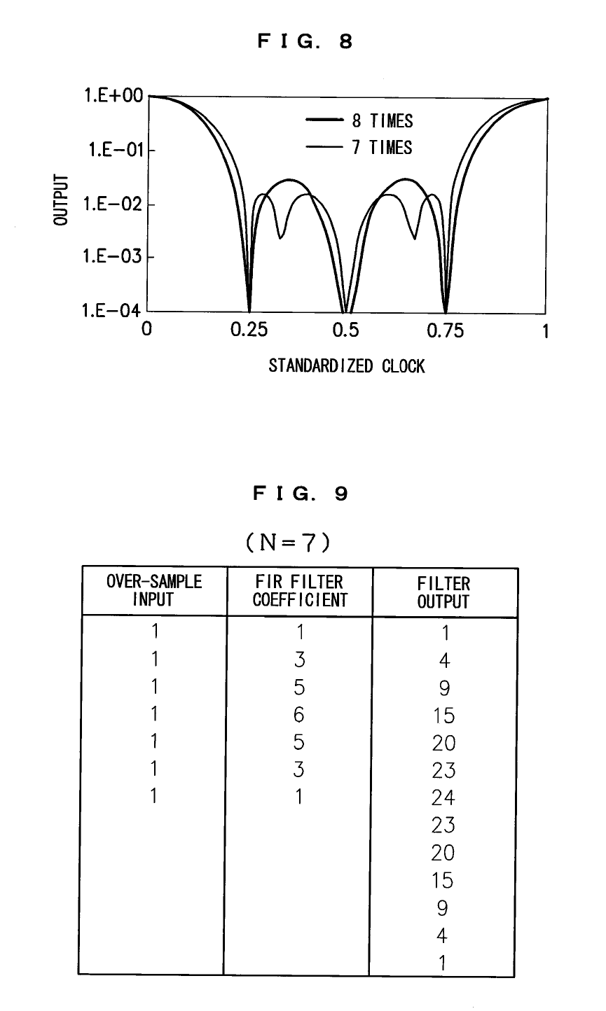

FIG. 7 is a graph showing a frequency characteristic of an output obtained when the unit pulse with amplitude “1” is inputted to the first FIR filter 21, i.e., a frequency characteristic of an impulse response of the first FIR filter 21. This is equal to a sequence of numerical values obtained by subjecting the sequence of numerical values {1, 1, 1, 1} to the fast Fourier transform. In FIG. 7, a frequency axis is standardized to set a maximum frequency value to “1” and an amplitude axis is standardized to set a maximum value to “1”. FIG. 8 is a graph showing a frequency characteristic of an impulse response of the FIR filter unit 3 (a sequence of numerical values obtained by subjecting the sequence of numerical values {1, 3, 5, 7, 7, 5, 3, 1} to the fast Fourier transform.). In FIG. 8, as in FIG. 7, a frequency axis is standardized to set a maximum frequency value to “1”.

The filter coefficients {1, 3, 5, 7, 7, 5, 3, 1} of the FIR filter unit 3 are generated by the structure shown in FIG. 6A. Therefore, a frequency characteristic of an impulse response thereof has a characteristic shown in FIG. 7 that represents the frequency characteristic of the first FIR filter 21. Actually, the two FIR filters 21 and 22 having the same filter coefficients {1, 1, 1, 1} are cascaded and the averaging processing unit 23 is connected at the post stage of the FIR filters 21 and 22. Thus, an attenuation in a blocking area increases as shown in FIG. 8 and a pass band is limited to 1/4 (=2/N=2/8) of the sampling frequency.

In the example explained above, N is 8. However, for example, when N is 7, since N is an odd number, the sequence of numerical values in (2) is used as the filter coefficients of the FIR filter unit 3. A sequence of numerical values in this case is specifically {1, 3, 5, 6, 5, 3, 1} (for simplification of explanation, denominators are omitted).

As shown in FIG. 9, when N is 7, a sequence of seven numerical values “1, 1, 1, 1, 1, 1, 1” is obtained according to the implementation of the over-sampling for the unit pulse with amplitude “1”. The FIR filter unit 3 inputs the sequence of numerical values “1, 1, 1, 1, 1, 1, 1” generated by the over-sampling and applies the filtering processing to the sequence of numerical values using filter coefficients formed by the sequence of numerical values {1, 3, 5, 6, 5, 3, 1} to obtain a sequence of thirteen numerical values {1, 4, 9, 15, 20, 23, 24, 23, 20, 15, 9, 4, 1}.

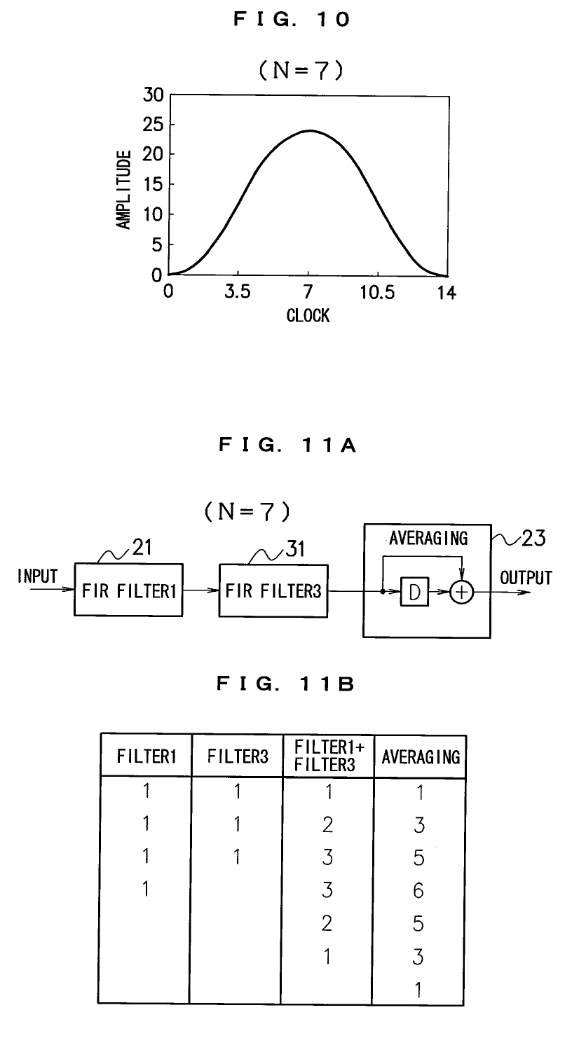

When amplitude values of the sequence of thirteen numerical values are plotted on the ordinate and clock positions are plotted on the abscissa to form a graph, a graph shown in FIG. 10 is formed. Like the curve shown in FIG. 4, a curve shown in FIG. 10 is a spline curve and indicates an interpolation function of a finite base that has finite amplitude values other than “0” only in clock positions between 0 and 14 and has all amplitude values of “0” in other areas.

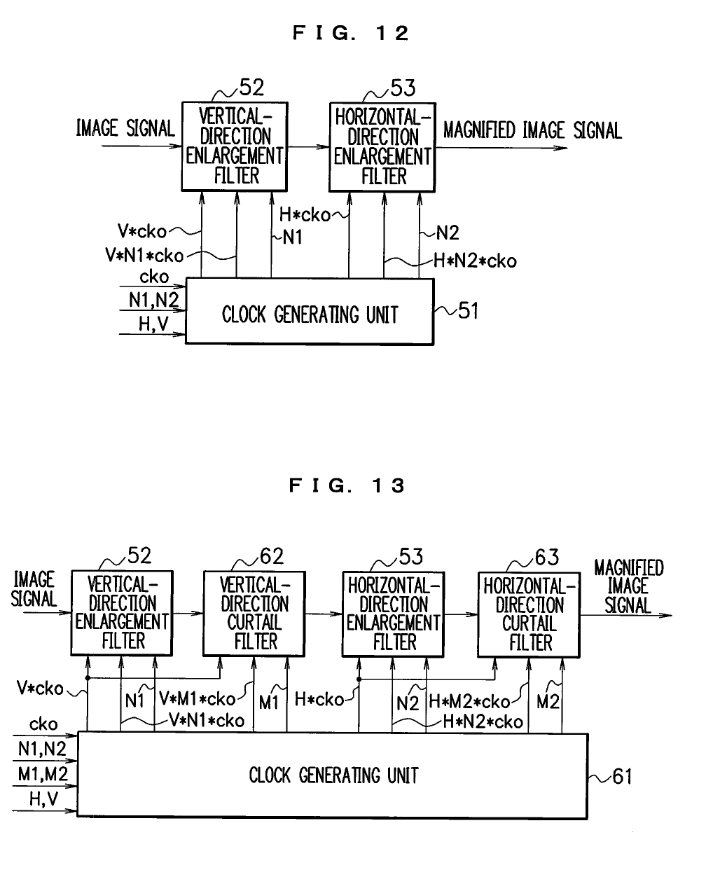

FIGS. 11A and 11B are diagrams showing an example of a structure of the FIR filter unit 3 in the case in which N is 7. In FIG. 11A, components having functions identical with those of the components shown in FIG. 6A are denoted by the identical reference numerals. As shown in FIG. 11A, the sequence of numerical values {1, 3, 5, 6, 5, 3, 1} is generated by the first FIR filter 21 having the sequence of numerical values {1, 1, 1, 1} as filter coefficients, a third FIR filter 31 having a sequence of numerical values {1, 1, 1} as filter coefficients, and the averaging processing unit 23 that averages a sequence of numerical values outputted from the third FIR filter 31.

As shown in FIG. 11B, when the unit pulse with amplitude “1” is inputted to the first FIR filter 21, the unit pulse passes through the cascaded two FIR filters 21 and 31, whereby a sequence of numerical values {1, 2, 3, 3, 2, 1} is generated. The sequence of numerical values is averaged by the averaging processing unit 23, whereby a sequence of numerical values {1, 3, 5, 6, 5, 3, 1} is generated.

A frequency characteristic of an impulse response of an impulse response of the filter coefficients {1, 3, 5, 6, 5, 3, 1} of the FIR filter unit 3 has a characteristic shown in FIG. 7 that represents the frequency characteristic of the first FIR filter 21. Actually, the two FIR filters 21 and 31 are cascaded and the averaging processing unit 23 is connected at the post stage of the FIR filters 21 and 31. Thus, an attenuation in a blocking area increases as shown in FIG. 8 and a pass band is limited to 2/7 (=2/N) of the sampling frequency.

As explained above in detail, one sample value is over-sampled to be sample values N times as many as the sample value by the over-sampling unit 2. The sample values are smoothed by the FIR filter unit 3. The number of the sample values is increased to substantially twice as many as N as shown in FIG. 4 or 10. Original sample points are smoothly interpolated by a spline curve. This spline curve indicates an interpolation function of a finite base. In such an interpolation function of the finite base, only data in local areas having finite values other than “0” have a meaning. Since data in areas other than the areas do not have to be logically taken into account, it is possible to reduce occurrence of a truncation error.

As a frequency characteristic of an output of the FIR filter unit 3, as shown in FIG. 8, a pass band is limited to 2/N of a sampling frequency. In this way, the digital filter according to this embodiment generates a smooth interpolation curve and, at the same time, performs band limitation corresponding to a scaling factor N of the over-sampling and the generated interpolation function. Thus, the low-pass filter for reducing aliasing noise is unnecessary. In other words, according to this embodiment, it is possible to reduce, without providing the low-pass filter at the post stage of the FIR filter unit 3 and providing the structure for the 0 value insertion in the over-sampling unit 2, aliasing noise caused by the interpolation processing performed by using the interpolation function.

An example in which the digital filter according to this embodiment constituted as described above is applied to an image processing apparatus that performs enlargement and reduction of an image will be explained. FIG. 12 is a diagram showing an example of a structure of an image processing apparatus according to this embodiment. As shown in FIG. 12, the image processing apparatus according to this embodiment includes a clock generating unit 51, a vertical-direction enlargement filter 52, and a horizontal-direction enlargement filter 53. The image processing apparatus performs enlargement of an original image formed by plural pixels arranged at equal intervals on a two-dimensional space.

The clock generating unit 51 inputs a clock ck0 of a reference frequency and inputs an enlargement ratio N1 in the vertical direction of an image, an enlargement ratio N2 in the horizontal direction of the image, a horizontal synchronizing signal H, and a vertical synchronizing signal V. The clock generating unit 51 generates clocks V*ck0, V*N1*ck0, H*ck0, and H*N2*ck0 of various frequencies from the clock ck0 of the reference frequency. The clock generating unit 51 outputs the clocks V*ck0 and V*N1*ck0 and the enlargement ratio N1 in the vertical direction to the vertical-direction enlargement filter 52. Further, the clock generating unit 51 outputs the clocks H*ck0 and H*N2*ck0 and the enlargement ratio N2 in the horizontal direction to the horizontal-direction enlargement filter 53.

The vertical-direction enlargement filter 52 has a structure same as that shown in FIG. 1 (however, a delay amount of the D type flip-flop is equivalent to one horizontal line). The vertical-direction enlargement filter 52 sequentially inputs pixel values of the respective pixels arranged at the equal intervals in the vertical direction on the two-dimensional space and performs the processing of the over-sampling unit 2 and the FIR filter unit 3 with N set to N1 to acquire pixel values N1 times as many as the pixel values in the vertical direction. Consequently, the original image is enlarged to be an image N1 times as large as the original image in the vertical direction.

The horizontal-direction enlargement filter 53 has a structure same as that shown in FIG. 1. The horizontal-direction enlargement filter 53 sequentially inputs pixel values of the respective pixels arranged at the equal intervals in the horizontal direction on a two-dimensional space enlarged to be N1 times the two-dimensional space in the vertical direction by the vertical-direction enlargement filter 52 and performs the processing of the over-sampling unit 2 and the FIR filter unit 3 with N set to N2 to acquire pixel values N2 times as many as the pixel values in the horizontal direction. Consequently, the image enlarged to be N1 time as large as the original image in the vertical direction is enlarged to be an image N2 times as large as the image in the horizontal direction.

As the vertical-direction enlargement filter 52 and the horizontal-direction enlargement filter 53, it is possible to prepare several FIR filter units 3 having structures corresponding to the plural kinds of enlargement ratios N1 and N2 in advance such that filter coefficients of the FIR filter units 3 can be switched according to the enlargement ratios N1 and N2 of an image and selectively use any one of the FIR filter units 3 on the basis of the enlargement ratio N1 or N2 inputted. It is also possible that the over-sampling unit 2 and the FIR filter unit 3 are constituted by, for example, DSPs (Digital Signal Processors), filter coefficients corresponding to the enlargement ratios N1 and N2 are saved in a memory such as a ROM, and the DSPs read out the filter coefficients from the ROM on the basis of the enlargement ratio N1 or N2 inputted and perform arithmetic operations.

FIG. 13 is a diagram showing an example of another structure of the image processing apparatus according to this embodiment. In FIG. 13, components having functions identical with those of the components shown in FIG. 12 are denoted by the identical reference numerals. The image processing apparatus shown in FIG. 13 includes a clock generating unit 61, the vertical-direction enlargement filter 52, a vertical-direction curtail filter 62, the horizontal-direction enlargement filter 53, and a horizontal-direction curtail filter 63. The image processing apparatus performs enlargement or reduction of an original image formed by plural pixels arranged at equal intervals on a two-dimensional space.

The clock generating unit 61 inputs a clock ck0 of a reference frequency and inputs an enlargement ratio N1 in the vertical direction of an image, an enlargement ratio N2 in the horizontal direction of the image, a reduction ratio M1 in the vertical direction, a reduction ratio M2 in the horizontal direction, a horizontal synchronizing signal H, and a vertical synchronizing signal V. The clock generating unit 61 generates clocks V*ck0, V*N1*ck0, V*M1*ck0, H*ck0, H*N2*ck0, and H*M2*ck0 of various frequencies from the clock ck0 of the reference frequency.

The clock generating unit 61 outputs the clocks V*ck0 and V*N1*ck0 and the enlargement ratio N1 in the vertical direction to the vertical-direction enlargement filter 52. The clock generating unit 61 outputs the clocks H*ck0 and H*N2*ck0 and the enlargement ratio N2 in the horizontal direction to the horizontal-direction enlargement filter 53. The clock generating unit 61 outputs the clocks V*ck0 and V*M1*ck0 and the reduction ratio M1 in the vertical direction to the vertical-direction curtail filter 62. Further, the clock generating unit 61 outputs the clocks H*ck0 and H*M2*ck0 and the reduction ratio M2 in the horizontal direction to the horizontal-direction curtail filter 63.

The vertical-direction enlargement filter 52 has a structure same as that shown in FIG. 1 (however, a delay amount of the D type flip-flop is equivalent to one horizontal line). The vertical-direction enlargement filter 52 sequentially inputs pixel values of the respective pixels arranged at the equal intervals in the vertical direction on the two-dimensional space and performs the processing of the over-sampling unit 2 and the FIR filter unit 3 with N set to N1 to acquire pixel values N1 times as many as the pixel values in the vertical direction. Consequently, the original image is enlarged to be an image N1 times as large as the original image in the vertical direction.

The vertical-direction curtail filter 62 curtails the pixel values of the respective pixels arranged at the equal intervals in the vertical direction on a two-dimensional space enlarged to be N1 times as large as the two-dimensional space in the vertical direction by the vertical-direction enlargement filter 52 to be pixel values 1/M1 times (M1 is an integer equal to or larger than 2) as few as the pixel values. Specifically, the vertical-direction curtail filter 62 outputs one signal per M1 lines among signals of respective lines forming an image enlarged to be N1 times as large as the original image in the vertical direction by the vertical-direction enlargement filter 52 to the horizontal-direction enlargement filter 53 at the next stage and curtails and discards signals of other lines. Since sample points are smoothly interpolated by the vertical-direction enlargement filter 52 at the pre-stage of the curtailment, even if sample values in the vertical direction is curtailed to sample values 1/M1 times as few as the sample values, an envelope of the sample values after the curtailment is also smooth.

The horizontal-direction enlargement filter 53 has a structure same as that shown in FIG. 1. The horizontal-direction enlargement filter 53 sequentially inputs pixel values of the respective pixels arranged at the equal intervals in the horizontal direction on a two-dimensional space enlarged to be N1/M1 times the two-dimensional space in the vertical direction by the vertical-direction enlargement filter 52 and the vertical-direction curtail filter 62 and performs the processing of the over-sampling unit 2 and the FIR filter unit 3 with N set to N2 to acquire pixel values N2 times as many as the pixel values in the horizontal direction. Consequently, the image enlarged to be N1/M1 time as large as the original image in the vertical direction is enlarged to be an image N2 times as large as the image in the horizontal direction.

The horizontal-direction curtail filter 63 curtails the pixel values of the respective pixels arranged at the equal intervals in the horizontal direction on a two-dimensional space enlarged to be N2 times as large as the two-dimensional space in the horizontal direction by the horizontal-direction enlargement filter 53 to be pixel values 1/M2 times (M2 is an integer equal to or larger than 2) as few as the pixel values. Specifically, the horizontal-direction curtail filter 63 outputs one signal per M2 pixels among signals of respective pixels forming an image enlarged to be N2 times as large as the original image by the horizontal-direction enlargement filter 53 and curtails and discards signals of other pixels. Since sample points are smoothly interpolated by the horizontal-direction enlargement filter 53 at the pre-stage of the curtailment, even if sample values in the horizontal direction is curtailed to sample values 1/M2 times as few as the sample values, an envelope of the sample values after the curtailment is also smooth.

According to the image processing apparatus constituted as shown in FIG. 13, it is possible to generate a magnified image obtained by enlarging the original image by N1/M1 times in the vertical direction and N2/M2 times in the horizontal direction. If N1 is set larger than M1, it is possible to obtain an image enlarged in the vertical direction. If N1 is set smaller than M1, it is possible to obtain an image reduced in the vertical direction. Similarly, if N2 is set larger than M2, it is possible to obtain an image enlarged in the horizontal direction. If N2 is set smaller than M2, it is possible to obtain an image reduced in the horizontal direction. According to the image processing apparatus according to this embodiment, it is possible to smoothly interpolate pixels of the original image using the spline curve and obtain an enlarged or reduced image with less aliasing noise with an extremely simple structure without providing the anti-alias filter and the structure for the value insertion.

In the embodiment, the example in which an image is enlarge or reduced in the vertical direction first and, then, the image is enlarged or reduced in the horizontal direction is explained. It is also possible to enlarge or reduce the image in the horizontal direction first and, then, enlarge or reduce the image in the vertical direction. However, it is preferable to enlarge or reduce the image in the vertical direction first because an arithmetic operation as a whole is simplified.

Besides, the above-mentioned embodiment only indicates an example of materialization in carrying out the present invention. The technical scope of the present invention should not be limitedly interpreted by the embodiment. In other words, it is possible to carry out the present invention in various forms without departing from the spirit or main characteristics thereof.

What is claimed is:

1. A digital filter comprising:
an over-sampling unit that repeatedly obtains inputted sequential respective sample values every N (N is an integer equal to or larger than 2) over-sampling periods to over-sample the respective sequential sample values to be sample values N times as many as the sample values by; and
an FIR filter unit that applies filter processing to the respective sample values over-sampled by the over-sampling unit using coefficients formed by a sequence of numerical values {1/2N², 3/2N², 5/2N², . . . , (N−3)/2N², (N−1)/2N², (N−1)/2N², (N−3)/2N², . . . , 5/2N², 3/2N², 1/2N²} (when N is an even number) or {1/2N(N+1), 3/2N(N+1), 5/2N(N+1), . . . , (N−2)/2N(N+1), (N−1)/2N(N+1), (N−2)/2N(N+1), . . . , 5/2N(N+1), 3/2N(N+1), 1/2N(N+1)} (when N is an odd number).

2. An image processing apparatus that performs at least one of enlargement and reduction of an original image formed by plural pixels arranged at equal intervals on a two-dimensional space, the image processing apparatus comprising:
a vertical-direction enlargement filter that sequentially inputs pixel values of respective pixels arranged at equal intervals in a vertical direction on the two-dimensional space and performs processing of the over-sampling unit and the FIR filter unit according to claim 1 with N set to N1 to acquire pixel values N1 times as many as the pixel values in the vertical direction; and
a horizontal-direction enlargement filter that sequentially inputs pixel values of respective pixels arranged at equal intervals in a horizontal direction on a two-dimensional space enlarged to be N1 times the two-dimensional space in the vertical direction by the vertical-direction enlargement filter and performs the processing of the over-sampling unit and the FIR filter unit according to claim 1 with N set to N2 to acquire pixel values N2 times as many as the pixel values in the horizontal direction.

3. The image processing apparatus according to claim 2, further comprising:
a vertical-direction curtail filter that curtails the pixel values of the respective pixels arranged at the equal intervals in the vertical direction on a two-dimensional space enlarged to be N1 times as large as the two-dimensional space in the vertical direction by the vertical-direction enlargement filter to be pixel values 1/M1 times (M1 is an integer equal to or larger than 2) as few as the pixel values; and
a horizontal-direction curtail filter that curtails the pixel values of the respective pixels arranged at the equal intervals in the horizontal direction on a two-dimensional space enlarged to be N2 times as large as the two-dimensional space in the horizontal direction by the horizontal-direction enlargement filter to be pixel values 1/M2 times (M2 is an integer equal to or larger than 2) as few as the pixel values, wherein
the horizontal-direction enlargement filter sequentially inputs pixel values of the respective pixels arranged at the equal intervals in the horizontal direction on a two-dimensional space enlarged to be N1/M1 times the two-dimensional space in the vertical direction by the vertical-direction enlargement filter and the vertical-direction curtail filter and performs the processing of the over-sampling unit and the FIR filter unit with N set to N2.
